(19) United States
(12) Patent Application Publication
(10) Pub. No.: US 2001/0002232 A1
(43) Pub. Date: May 31, 2001

(54) METHOD AND SYSTEM FOR FORMING CUSTOM SHOE INSOLES

(76) Inventors: DANIEL DAVID YOUNG, SATELLITE BEACH, FL (US); KENNETH ADAIR WHEELER, GRANT, FL (US); FRANK PAUL BISCRDI, MELBOURNE, FL (US); EDWARD BROOKS MOORE, NAPLES, FL (US)

Correspondence Address: SIXBEY, FRIEDMAN, LEEDOM & FERGUSON, 8180 GREENSBORO DRIVE SUITE 800, MCLEAN, VA, 22102

(21) Appl. No.: 09/270,688

(22) Filed: Mar. 16, 1999

(51) Int. Cl. B23C 1/00; G06F 19/00; G01V 8/00; G01N 21/86

(52) U.S. Cl. 409/132; 700/163; 250/559.22; 409/96

(57) ABSTRACT

The present invention includes a method for forming a custom-made insole including the step of positioning a foot to be measured on a scanning station. The scanning station includes at least one laser unit which is passed along an undersurface of the foot. The undersurface of the foot is scanned by the at least one laser scanning unit which measures the detected surface coordinates of the undersurface. The measured surface coordinates are processed and transmitted to a computer. A milling station, in communication with the scanning station and computer, includes a milling assembly for forming the custom-made insole. The computer controls the operation of the milling assembly based upon the coordinates determined by the at least one laser scanning unit.

### BACKGROUND OF THE INVENTION

1. Field of the Invention

The present invention relates to a method and system for forming custom-made apparel, and more particularly to method and system for forming custom-made insoles, wherein the bottom surface of the foot is measured by a laser scanning station and the measurements are forwarded to a milling station where the custom-made insole is produced.

2. Description of the Related Art

It is well known to form a shoe by taking manual measurements of an individual's foot, forming a last or impression of the foot and forming a shoe which conforms to the last. However, such devices do not measure the contours of the undersurface of a person's foot, which is crucial for comfort.

Numerous systems have been devised to measure the contours of an undersurface of a foot and manufacture an insert based upon such measurements. As disclosed in U.S. Pat. Nos. 5,640,779; 4,449,264; 4,517,696; 4,510,636; and 4,454,618, it is known to form a foot impression by an array of gauging elements which contact the underside of the foot and produce digital signals indicative of the position of each element.

One disadvantage of such a system is the inaccuracy of the data received. The digital representations formed by the above apparatuses must be modified to compensate for characteristics not detected. Another disadvantage is that such devices must contact the surface being measured, which can cause inaccuracies if movement is to occur during measurement, as well as, discomfort to the customer.

U.S. Pat. No. 5,128,880 discloses a non-contact foot measuring device whereby a color copy of the undersurface of a person's foot is measured and based on color level, distances are assigned. An inherent disadvantage with this system is the difficulty, if not impossibility, of correlating color level with foot contours.

To overcome the inadequacies of contact foot measurement devices and to improve measurement accuracy, optical techniques have been employed for foot measurement. U.S. Pat. No. 4,745,290 discloses a method and apparatus for making a custom shoe. A rotating scanner and laser beam splitter direct one beam past the left side of a leg and a second beam past the right side of the leg. The beams impinge from the foot to a fixed mirror and are reflected to an oscillating mirror. From the oscillating mirror the beams are independently reflected back to the scanner and then focused by a lens upon a linear detector.

It is impossible to use the apparatus of U.S. Pat. No. 4,745,290 to measure the entire undersurface of a foot. Another disadvantage is that the foot to be measured must be placed in an exact predetermined position for the device to operate properly.

U.S. Pat. No. 4,662,079 also discloses using a laser beam to measure the upper surfaces of a foot to form a custom-made shoe or inner bladder. The device measures the natural or neutral position of a foot by determining a range of motion by the laser beam, a mirror and an associated scale. One disadvantage with this device is that it is not capable of measuring the undersurface of the foot. Also, once the desired position is measured the user must remain still until a mold is formed around the foot.

U.S. Pat. No. 5,671,055 discloses a laser measurement apparatus which creates a three-dimensional profile of a foot. Based upon the profile an accurate shoe size can be selected. This method and apparatus is not capable of manufacturing a custom-made insole because it is impossible to measure the undersurface of the foot.

Therefore, it is desirous to have method and system for measuring the undersurface of a foot, reliably and accurately without contacting the foot itself.

### SUMMARY OF THE INVENTION

An object of the present invention is to provide a system and method for forming a custom-made insert wherein the undersurface of a foot is accurately and quickly measured by laser scanning.

Another object of the present invention is to manufacture a custom-made insole directly from the coordinates detected by the laser measurement.

A further object of the present invention is to provide a system and method which is simple to use and suitable for use in a retail environment.

Still another object of the present invention is to provide a system and method for measuring the coordinates of the undersurface of a foot with high three dimensional accuracy, storing the measured coordinates and manufacturing a custom-made insole based on the stored coordinates.

With the system and method of the present invention, the placement of the foot in the scanning station is entirely random, i.e., no reference to foot placement is necessary.

In accomplishing these and other objectives of the present invention, there is provided a method for forming a custom-made insole including the step of randomly positioning a foot to be measured on a scanning station. The scanning station includes at least one laser unit which is passed along an undersurface of the foot. The undersurface of the foot is then scanned and the detected surface coordinates of the undersurface are measured. The measured surface coordinates are processed and transmitted to a computer. A custom-made insole can be milled based on the transmitted surface coordinates.

In a preferred embodiment, a system for forming a custom-made insole includes a scanning station for supporting a foot to be measured. The scanning station includes at least one movable laser scanning unit for determining coordinates of an undersurface of the foot. A milling station, in communication with the scanning station, includes a milling assembly for forming the custom-made insole. A computer controls the operation of the milling assembly based upon the coordinates determined by the at least one laser scanning unit.

Other features and advantages of the present invention will become apparent from the following description of the invention which refers to the accompanying drawings.

### BRIEF DESCRIPTION OF THE DRAWINGS

FIG. 1 is a perspective view of the scanning and milling system of the present invention.

FIG. 2 is a detailed view of the milling station of the present invention.

FIG. 3 is a front view of the milling station.

FIG. 4 is a side view of the milling station.

FIG. 5 is a side view of the upper unit of the milling station.

FIG. 6 is a top view of the milling assembly of the present invention.

FIG. 7 is a front view of the milling assembly of FIG. 6.

FIG. 8 is a cross-sectional view of the milling assembly taken along line I-I of FIG. 7.

FIG. 9 is a rear perspective view of the lower stand of the milling station.

FIG. 10 is a rear view of the lower stand of FIG. 9.

FIG. 11 is a perspective view of the vacuum system of the present invention.

FIG. 12 is a cross-sectional view of the vacuum system taken along line II-II of FIG. 11.

FIG. 13 is a front perspective view of the lower stand of the milling station.

FIG. 14 is a cross-sectional view of the scanner station taken along line III-III of FIG. 1.

FIG. 15A is a perspective view of the inner structure of the scanner station.

FIG. 15B is a perspective view of a laser scanning unit.

FIG. 15C is a scanning illustration of the laser units.

FIG. 16 is a front view of the scanner station of FIG. 15A.

FIG. 17 is a side view of FIG. 15A.

FIG. 18 is a top view of FIG. 15A.

FIG. 19 is a top view of a homing board of the present invention.

FIG. 20 is a wiring diagram of the milling station of the present invention.

FIGS. 21A and 21B are circuit diagrams for determining router motor current and stepper motor feed rate.

FIG. 22 is a top view of an insole blank during milling.

FIG. 23 is a schematic illustration of the scanner station, milling station and computer of the present invention.

FIG. 24 is a flow chart of the software routine executed by the system of the present invention.

FIG. 25 is an example form displayed to a user of the system of the present invention.

FIG. 26 is a block diagram illustrating a signal conditioning algorithm of the present invention.

### DETAILED DESCRIPTION OF THE PREFERRED EMBODIMENTS

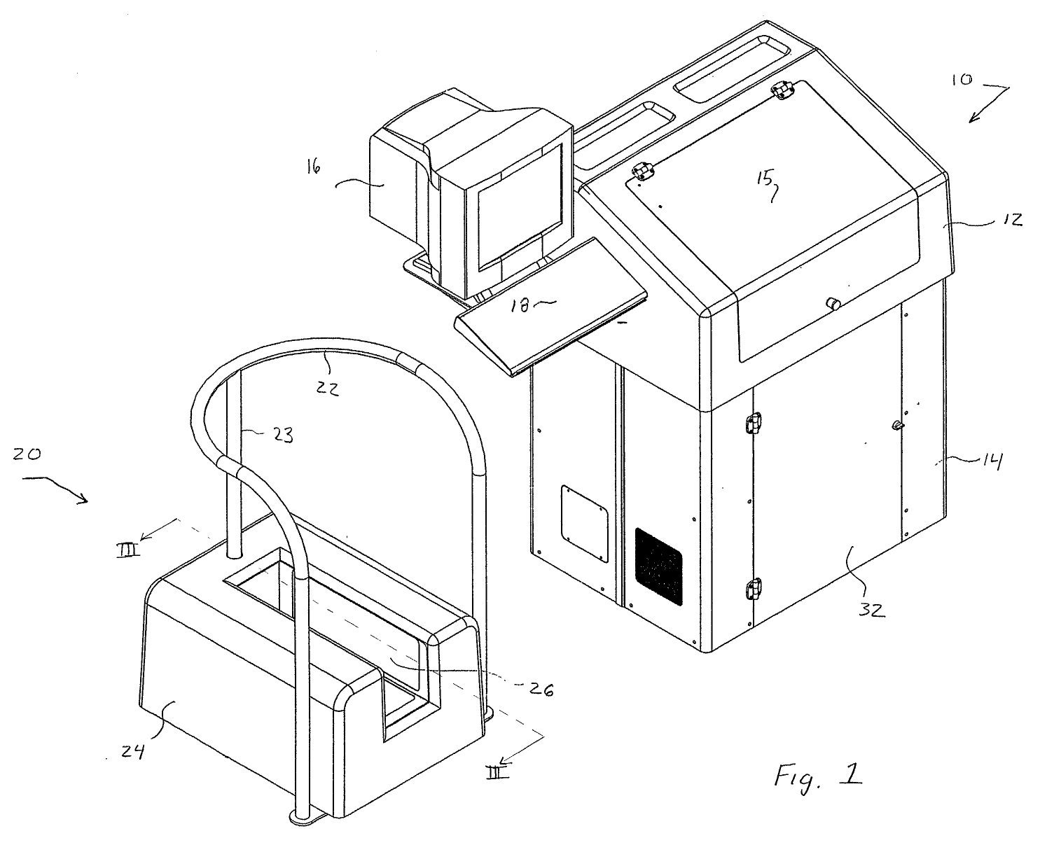

Referring to FIG. 1, the present invention comprises a milling station 10 and a scanning station 20 for determining coordinates of an undersurface of a customers foot and producing a custom-made insole based upon the determined coordinates. The system is designed for use in a retail environment, whereby a trained user can measure, quickly and accurately, the undersurface of a customers foot and in turn manufacture the insoles directly for purchase.

Milling station 10 includes an upper unit 12 and a lower unit or stand 14. A lid 15 encloses the milling assembly 40, which will be described further herein. A monitor or display 16 and input or keyboard 18 allow the user to operate the system. Although the system operation is described via both stations 10 and 20, milling station 10 is capable of being operated independently of scanner station 20. Moreover, a plurality of scanner stations located in different locations could communicate with a single or multiple remote milling stations. Depending on the environment of use, the scanner station could include the computer processing means.

Scanning station 20 includes a base 24 which has a U-shaped channel 26 into which the customer places his/her foot to be measured. Bar 22 helps position and stabilize the customer during the scanning operation. Although not shown, station 20 could include a leg support extending inwardly from pole 23 upon which the user could stabilize his/her lower leg during scanning.

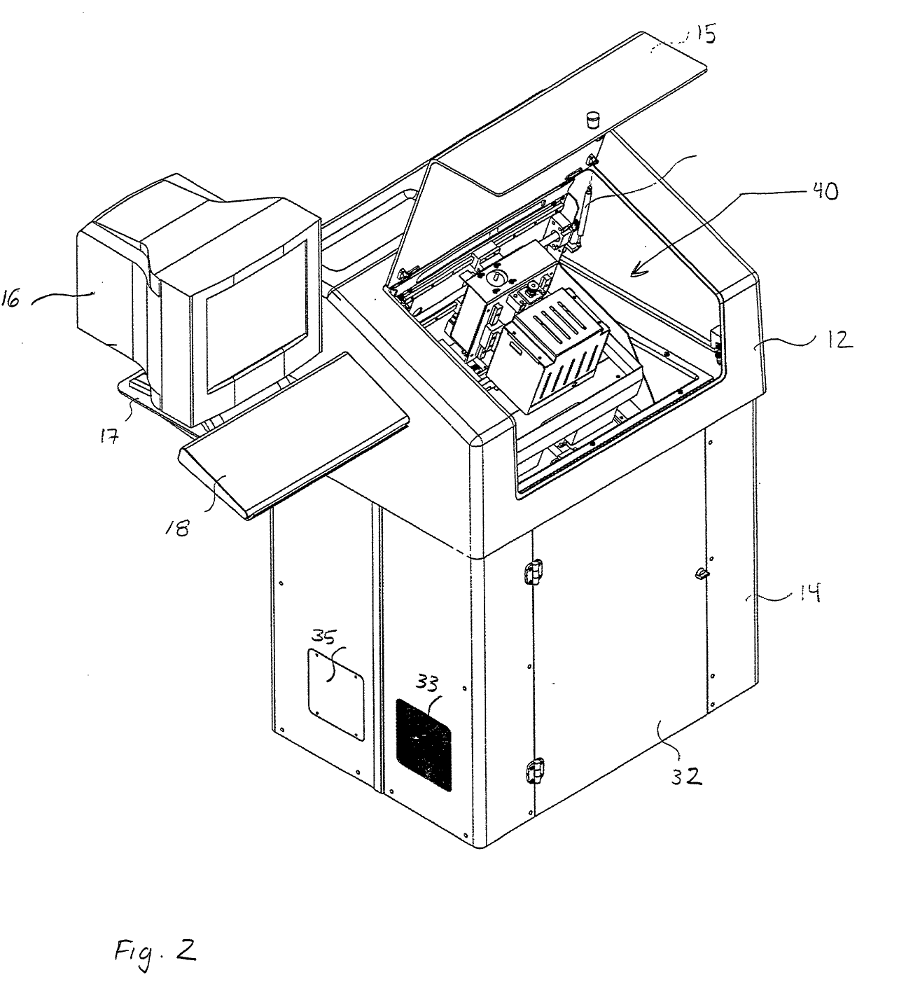

FIG. 2 is a detailed illustration of milling station 10. Lower stand 14 includes a front access door 32. The stand 14 can be made of sheet metal or any other suitable material, such as a heavy duty plastic. Stand 14 includes an access panel 35 and vent 33. Upper unit 12 can also be made of any suitable material, for example, plastic. Lid 15 is clear for visual inspection and marketing purposes. The lid 15 is held open by gas springs 34 and includes a slam latch for keeping the lid closed. Underneath lid 15 is the milling assembly 40.

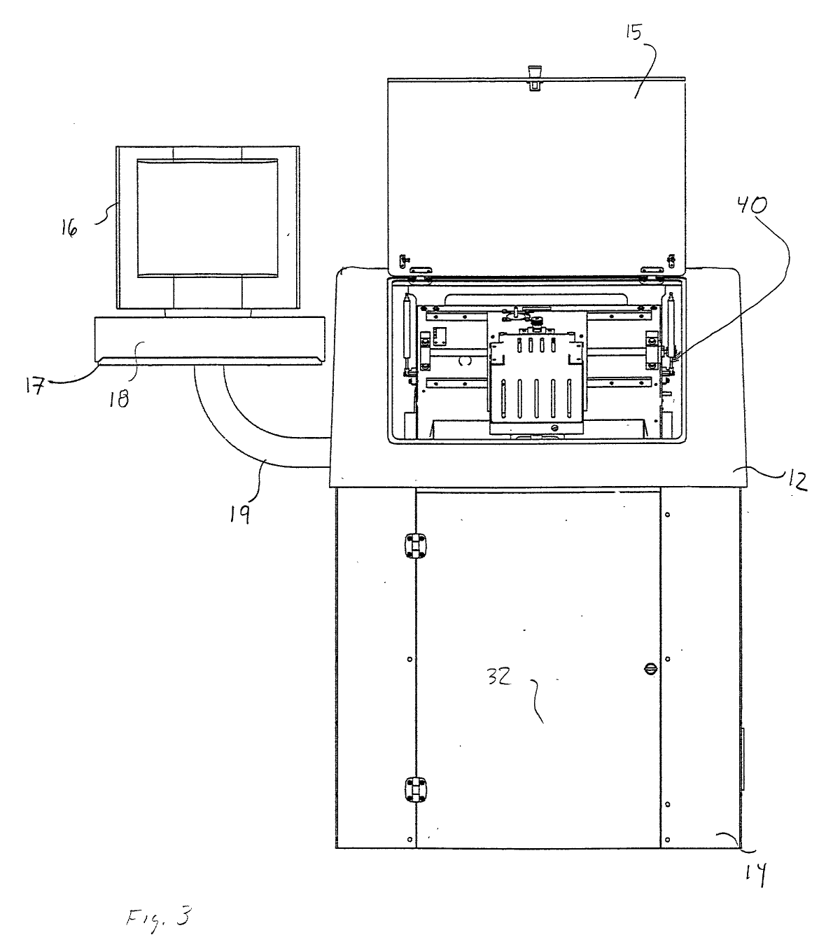

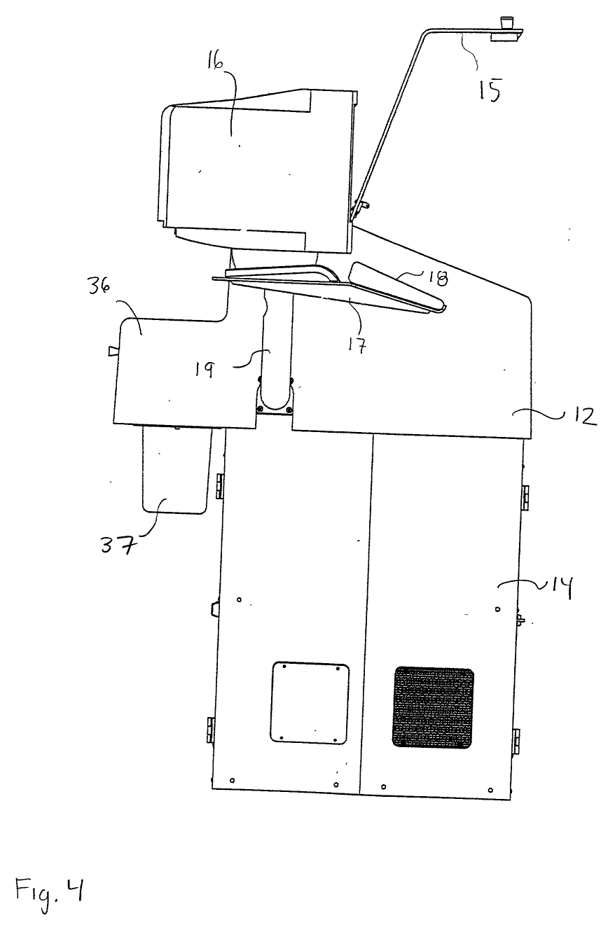

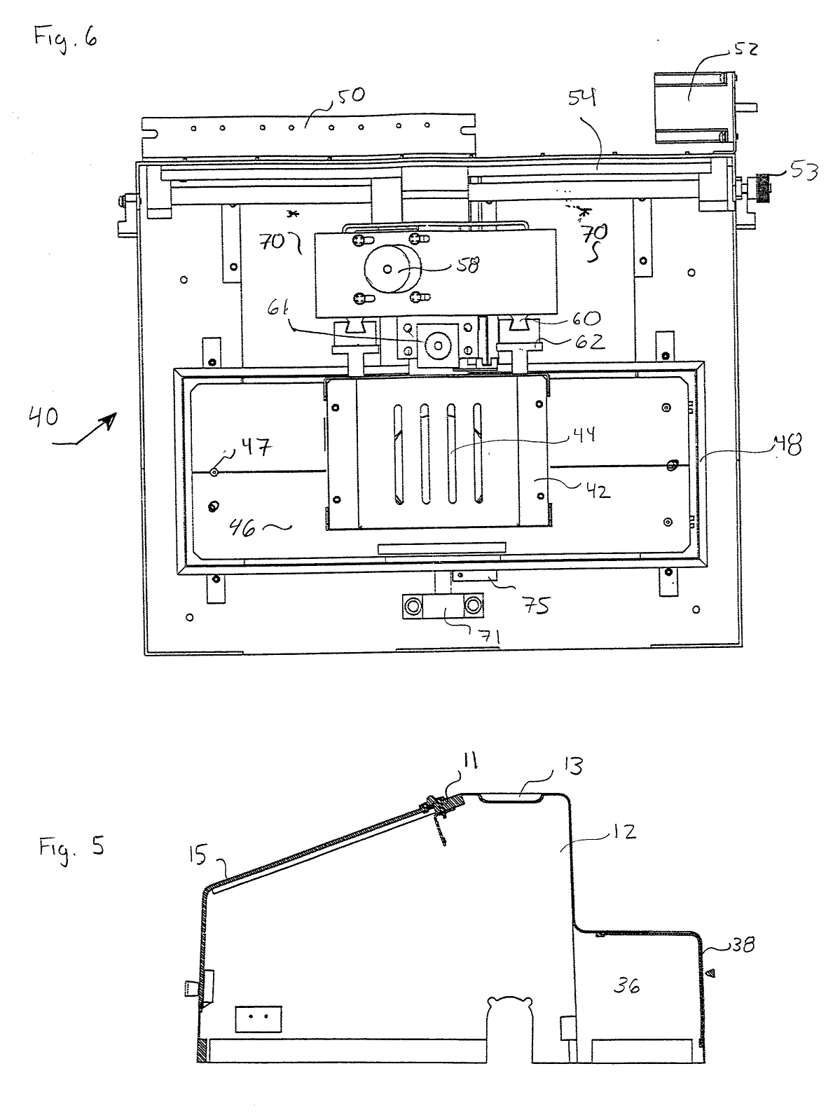

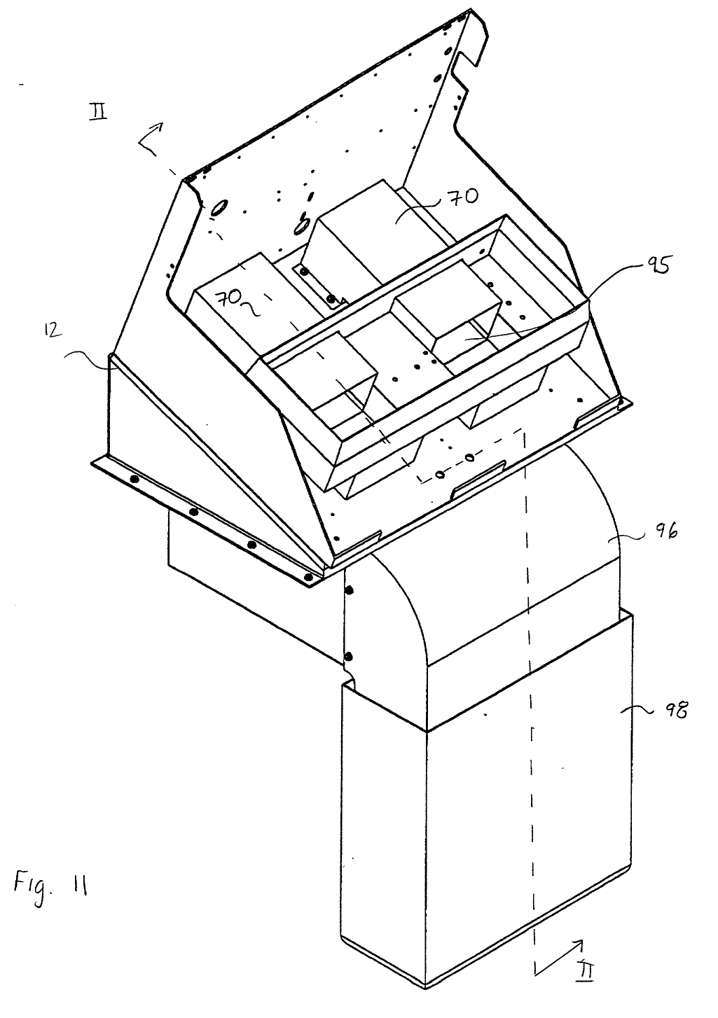

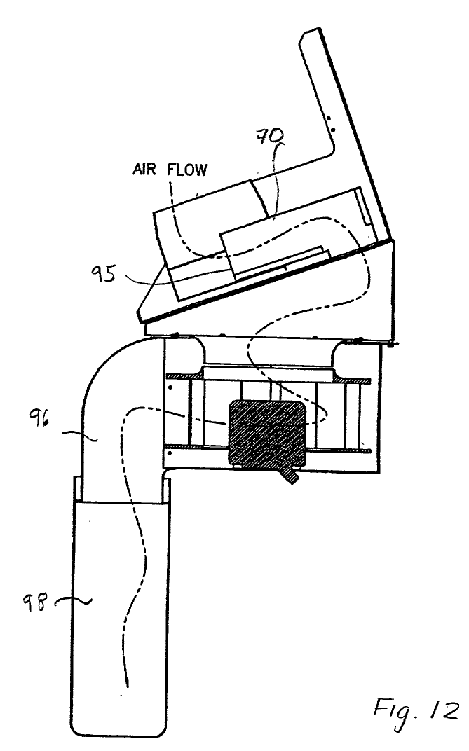

FIG. 3 is a front view of milling station 10. Monitor 16 and keyboard 18 are supported by a shelf 17. A support arm 19 attaches shelf 17 to lower unit 14. Lower unit 14, as shown in FIG. 4, includes a portion 36 which houses a grinder (shown in FIG. 9) for finishing the insole after milling. A hopper 37 for collecting debris from the grinder extends downwardly from grinder housing 36. As shown in FIG. 5, grinder housing 36 includes a door 38 for gaining access to the grinder. Upper unit 12 also includes indentations 13 which can hold pens, clips, etc.

The lid 15 communicates with a shut-off switch 11, whereby if lid 15 is opened during router operation switch 11 will automatically shut-off the router. If lid 15 is opened or closed during operation the router will recall it's last position during milling.

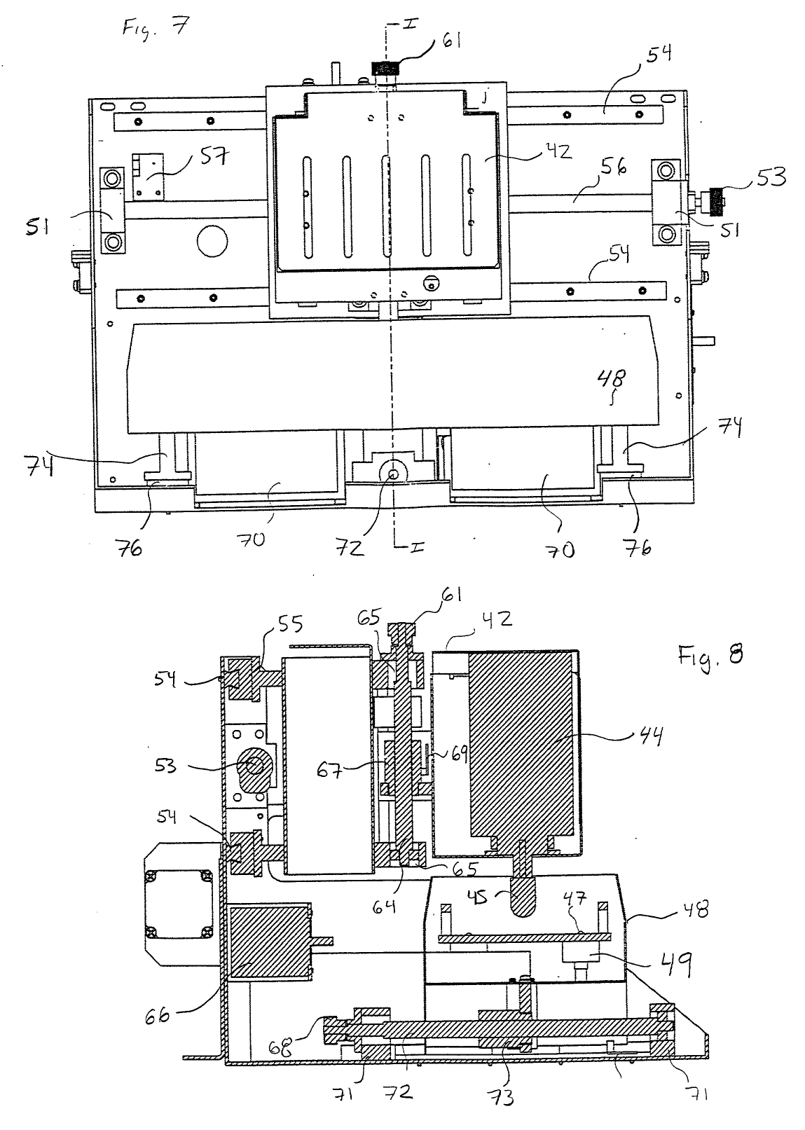

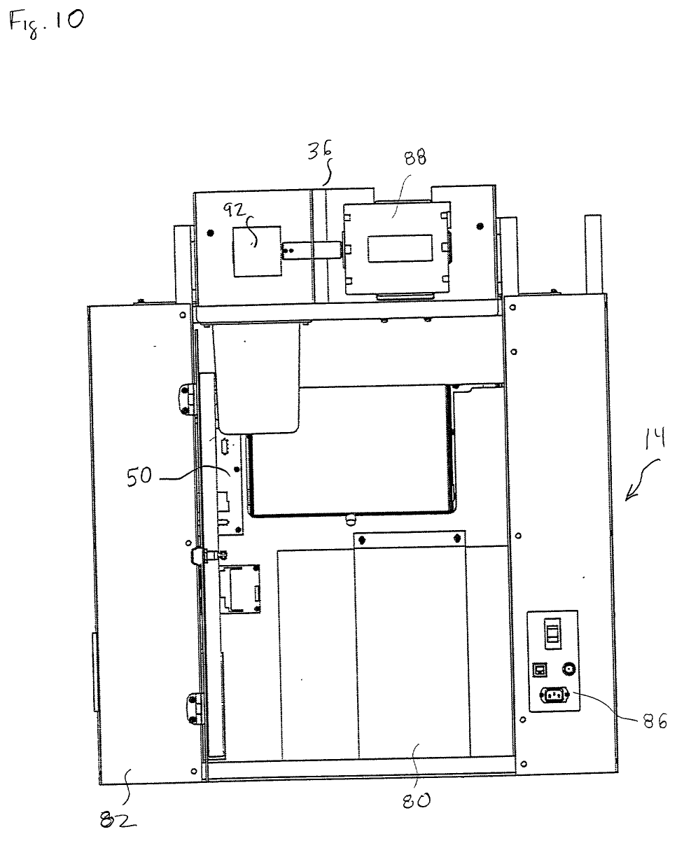

Next, the milling assembly 40 will be described in detail. As shown in FIG. 2, the entire milling assembly 40 is positioned at an angle, for example, 20°, for viewing purposes and dust collection. FIG. 6 illustrates a top view of milling assembly 40. Router 44 is located within vented router housing 42, which is mounted so that movement along two axes is possible. Located below router 44 is an insole mounting plate 46, upon which the insole to be custom machined is removably mounted, for example, by adhesive provided on the insole blank. Plate 46 is removably mounted to a tray 48 via pins 47 and electromagnet 49, shown in FIG. 8. Pins 47 align the plate on tray 48 and electromagnets 49 hold the plate in place. The mounting of plate 46 allows for easy removal and cleaning.

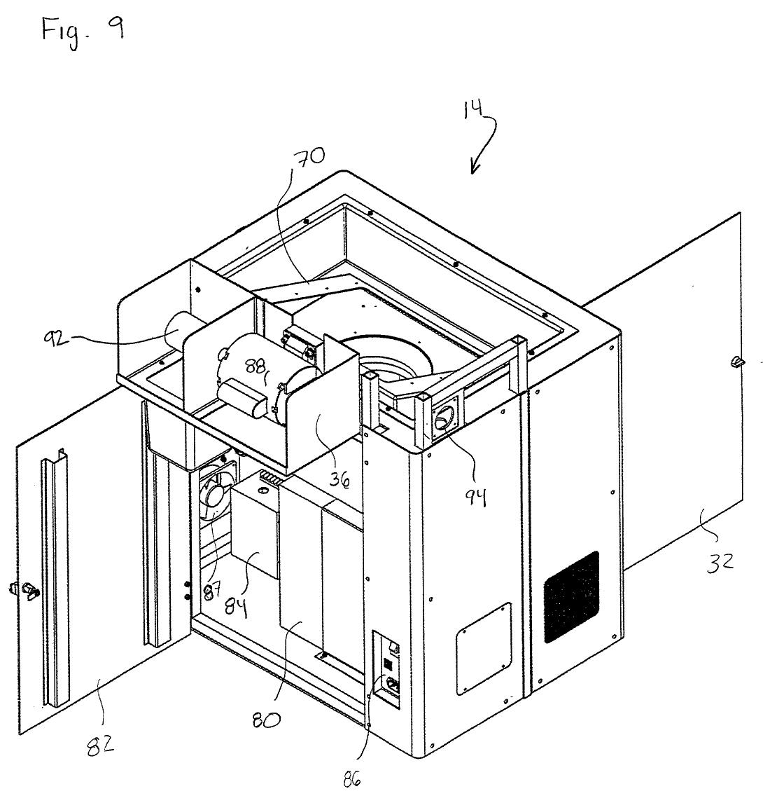

The movement of router housing 42 and tray 48 are controlled by a plurality of stepper motors. A three-axis stepper control board 50 controls the operation of the stepper motors. A first stepper motor 52 moves router 44 from side-to-side or along a Y-axis of movement. Motor 52 operates with a pulley 53, a belt (not shown) and a ball screw 56 to move the router 44 along slides 54 and a ball screw 56, shown clearly in FIG. 7. Tray 48 is movable along a third axis.

A second stepper motor 58 controls the vertical movement of router 44 to vary the depth of milling. Motor 58 communicates with timing pulley 61 via a belt (not shown) to move router 44 along slides 60 and ball screw 64. A two-piece bracket 62 attached to the router housing moves along slides 60. Therefore, the router 44 and housing is designed to move side-to-side along a first axis of movement, or along a Y-axis, as well as, along a second axis of movement, vertically or along the Z-axis.

Referring to FIGS. 7 and 8, insole tray 48 is mounted to move front-to-back along a third axis of movement, or along the x-axis. A third stepper motor 66 communicates with timing pulley 68 and ball screw 72 to move tray 48. As illustrated in FIG. 7, brackets 74 mounted to tray 48 move along slides 76 to effect the movement of tray 48. Screw 72 is supported on its ends by bearing blocks 71 and internally by ball nut 73. Likewise, screw 56 is supported by bearing blocks 51. Ball screw 64 which allows for vertical movement of the router is supported by bearing blocks 65. Each of the assemblies for movement of the router and tray communicate with a homing board, which will be described in detail further herein. As shown in FIG. 6, homing board 75 indicates movement of tray 48 front-to-back or along the x-axis. Referring to FIG. 7, another homing board 57 indicates the side-to-side, or y-axis movement of the router. A third homing board 69, shown in FIG. 8, indicates the vertical, or Z-axis movement of the router.

Referring again to FIG. 8, router 44 includes a tool bit 45, such as bit no. BN34 manufactured by L. R. Oliver of Michigan. Although not shown, a latex skirt could be provided about bit 45 to contain and control particle debris.

FIG. 9 illustrates lower unit or stand 14. Backdoor 82 provides access to computer 80, and power supply 84. An IO panel 86 includes an on/off circuit breaker as well as an AC power socket. Grinder housing 36 located behind the milling assembly houses grinder motor 88 and grinder 92. Plenum 70 is angled to mate with the milling area. Also shown is aperture 94 which receives arm 19 for supporting the computer monitor and keyboard shelf.

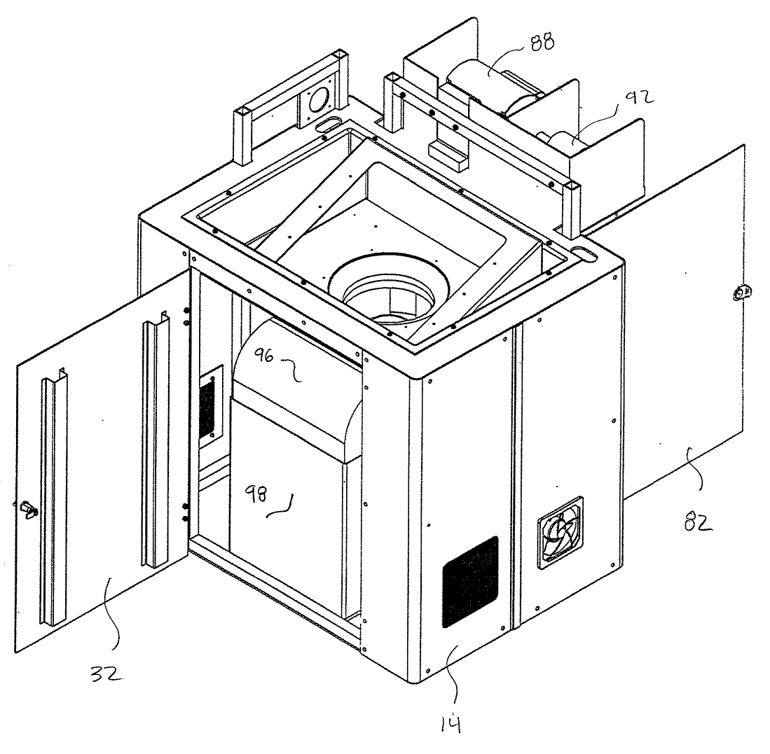

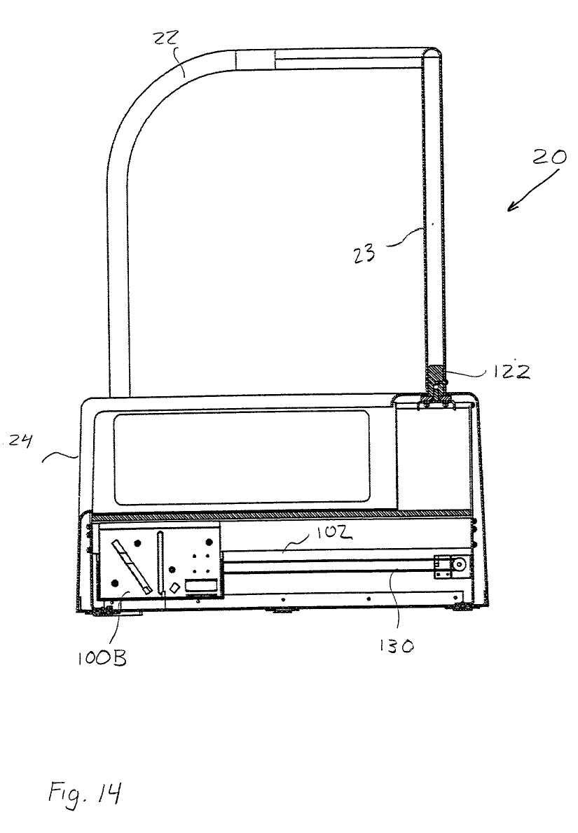

The vacuum system of the present invention is shown in detail in FIGS. 11 and 12. Air plenums 70 remove the debris or shavings produced during the insole milling process. The entrance 95 to plenums 70 are positioned below tray 48 such that during milling of the insole the tray is moved so that the edge where the bit is machining is located at the plenum entrance.

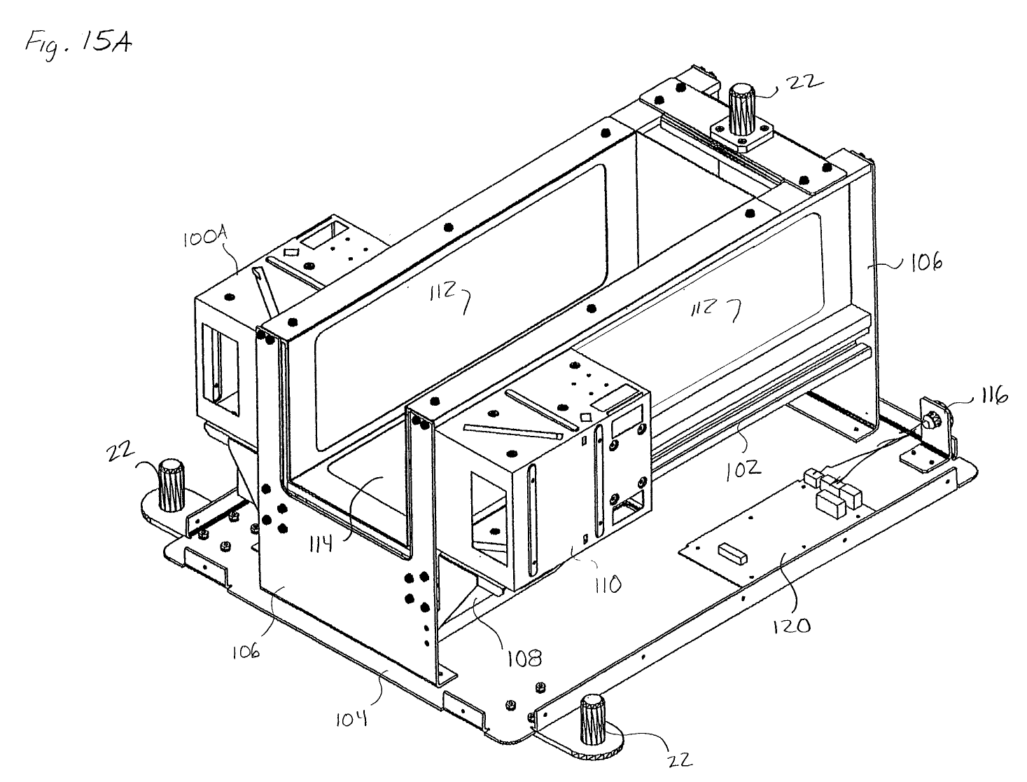

As shown in FIGS. 11-13, a duct 96 and dust bag 98 communicate with plenum 70 to remove particles by vacuum. Referring to FIG. 12, the air flow, which is at near maximum flow, is assisted by gravity due to the angle of upper unit 12. The particles are allowed to settle and then are captured by the air flow through entrance 95. The vacuum system of the present invention operates at a high volume, for example, 1200 cu. ft./min., but a low velocity. If the velocity of the air flow is too high the air moves too fast to grab the particles of debris. Thus, the particle laden air enters at entrance 95 and is pulled through duct 96 into bag 98.

Dust bag 98 has a certain porosity. For example, the bag can be made of felt having a porosity of 120 cfm. The bag can also be semi-rubberized on an interior surface for emptying ease or could be made of an inexpensive material if the bag is not reusable.

The milling assembly 40 can be coated or provided with a charge such that dust and particle debris is repelled from the surfaces thereof. Although not shown, vacuum points could be provided about the bit of the router to remove the particles during milling. Other methods of dust collection, especially in light of industrial forming applications, could be used in the present invention.

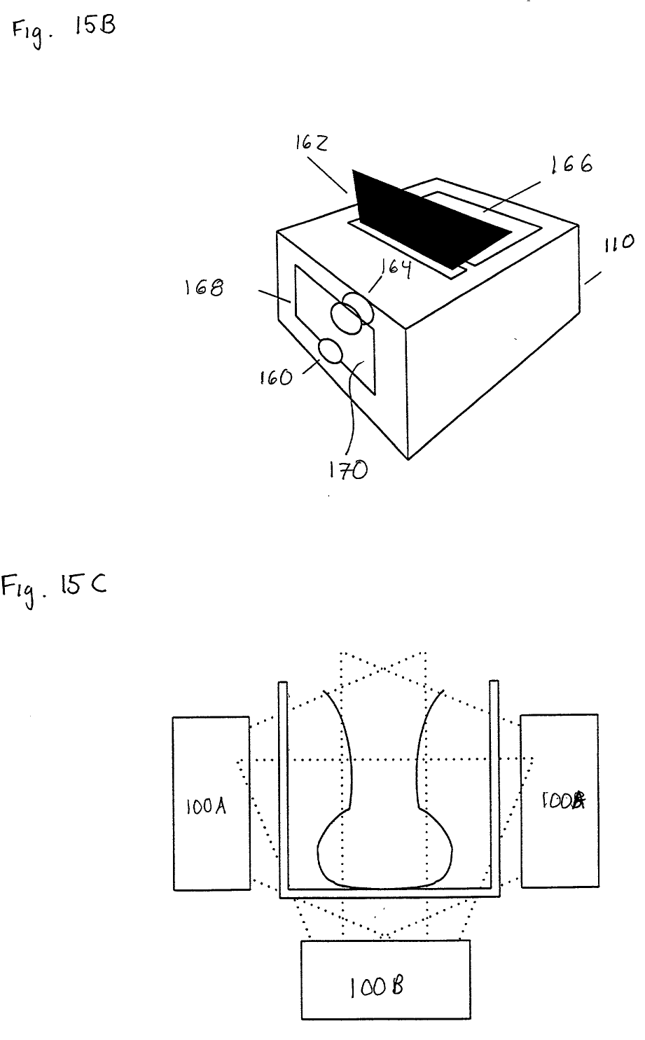

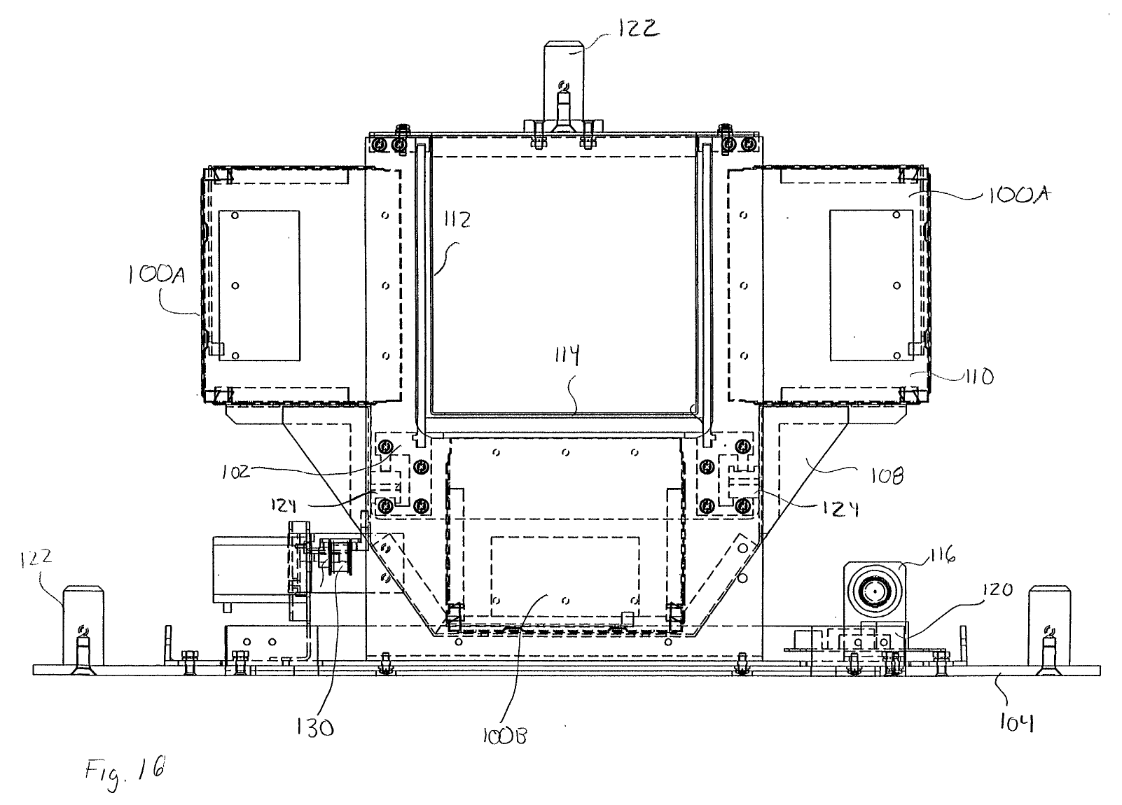

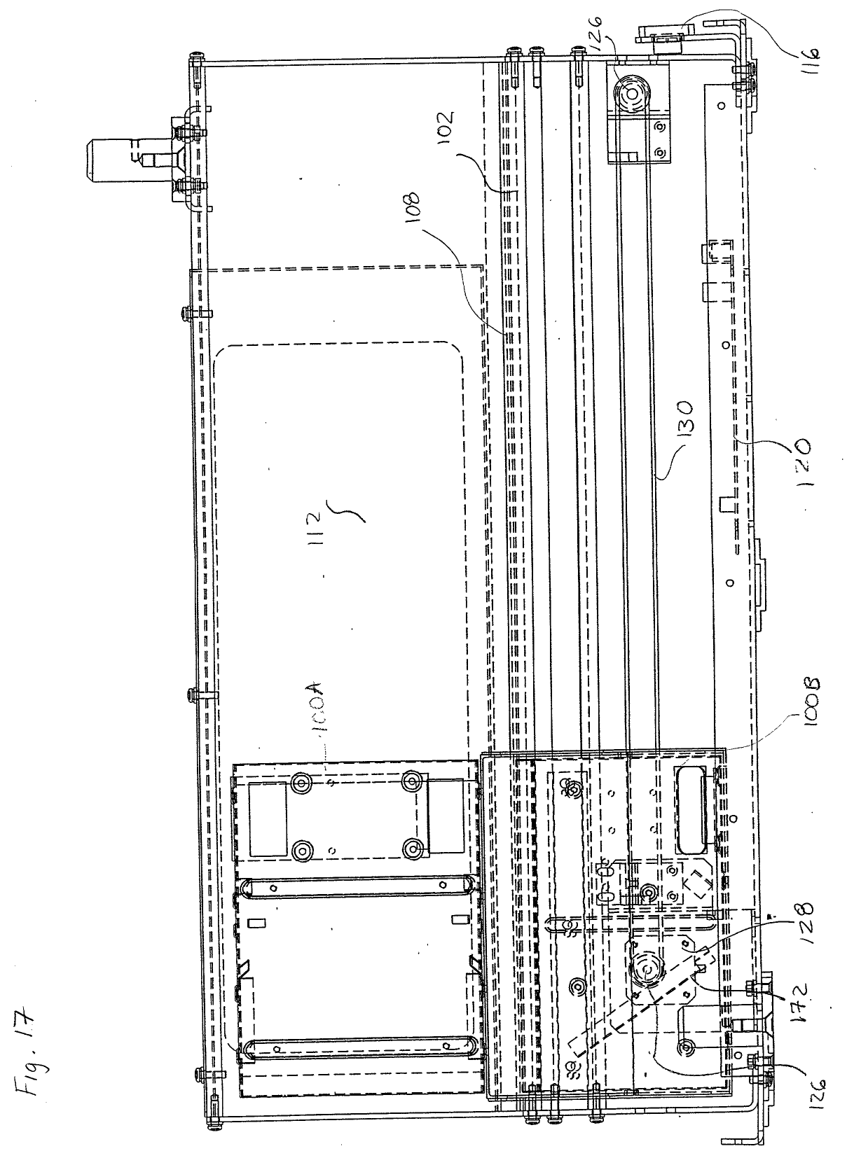

FIG. 14 is a cross-sectional illustration of scanning station 20 taken along line III-III in FIG. 1. A laser scanner unit 100, which will be described further herein, is mounted for movement along support rail 102. The station includes two side laser scanner units 100A, shown in FIG. 15A, as well as, a bottom laser scanner 100B unit shown in FIG. 16. The laser units scan at least the bottom surface and edges of the foot, such that the unique surface coordinates thereof are accurately measured to produce a custom-made insole, which is discussed further herein.

The laser technology used in scanners 100 is disclosed in U.S. Pat. Nos. 4,645,347; 5,270,795; 4,658,368 and 4,819,197, herein incorporated by reference. U.S. patent application Ser. No. 08/___,___, entitled “Virtual Multiple Aperture 3-D Range Sensor” filed Feb. 4, 1999, is also incorporated herein by reference. As the laser units are moved along the foot an unfocused laser line or fan-shaped beam is directed at the foot and edges thereof.

The laser scanning units use a ⅔″ CCD imaging device and have low level peak-validation and intrinsic calibration methods (API). Also included are central controlling processor and motion control, USB host computer communication, video signal processing and peak detection, upward compatible range data processing algorithms and compatibility with most GUI interfaces.

The laser scanning units operate in a manner similar to the Biris/Insight principle which uses a dual-aperture mask located inside a standard camera lens for ranging and signal validation. The present ranging method projects a line on the object to create a double image of the line or lines on the imaging sensor whose separation is a function of the range measurement. By measuring the location of the laser lines on an imager, distance between the sensor and the object is calculated using triangulation. Sub-pixel peak detection and validation procedures create a very robust range detection method. The dual measurements create range redundancy that is used to increase the accuracy of the range data. This dual information is also used to validate the measurements by eliminating false readings (outliers).

The ranging method of the above-incorporated technology has a high immunity to optical perturbations and allows for the use of the scanning stations in bright places, such as shopping centers, stores or medical offices. Other advantages of virtual multiple apertures are higher immunity to false measurements, upward compatibility with previous ranging algorithms, physical compactness and low cost, no mask aperture is required, it can be used with short focal length lens and increased accuracy and sensitivity.

The laser sensors are designed to reduce the cost of the unit, as well as to meet the requirements of measuring a variety of different feet. Thus, the sensors incorporate a number of new technologies, i.e., smaller format CMOS camera, smaller off-the-shelf camera lens, electronics to multiplex multiple sensors together, mirrors to bend the light rays into a package suitable for the application and the high immunity to other scanning lasers and external light sources.

The basis principle for obtaining three-dimensional information is the imaging of a fan-shaped laser line through two apertures displaced laterally. The image of the laser line is observed with a CCD camera. If the laser line as seen by the camera is a flat object, all of the pixels from the two virtual apertures will be identical. However, if the object has a shape, the laser line will not be observed in the same pixel as the previous flat surface. The difference, when coupled with calibrated signal strength, allows the determination of pixel-by-pixel signals, which directly correlate to an accurate 2-dimensional distance measurement. By moving the fan-shaped laser line along the entire foot the 3-dimensional shape thereof can be determined. The non-contact laser units provide extremely accurate three-dimensional topographical data, with a data point being taken every 0.2 mm, i.e., the accuracy is +/−0.2 mm, 1 sigma signal point accuracy in the z axis. The sampling density is a minimum of 3.0 mm on both the x and y axis. The scan depth and scan width is approximately 6 inches.

The inner structure of scanner station 20 is shown in FIG. 15A and includes base 104 and support structures 106 extending upwardly therefrom. Two support rails 102 extend between supports 106 along the length of base 104 on either side. The support rails 102 act as a track for the translation of carrier 108. The side laser units 100A are attached to on the sides of carrier 108 and bottom scanner 100B is attached beneath carrier 108, as shown in the drawing figures. The laser units can be attached to carrier 108 by conventional means, such as pan-head screws.

Located above support rails 102 on each side is a portion of tempered safety glass 112 having a thickness of, for example, 3/16″. Another piece of tempered safety glass 114 is positioned to act as a base, such that the customer places his/her foot directly thereon. For improved strength safety glass 114 should be thicker, for example, ⅜″. This bottom glass can support a customer weighing up to 500 lbs.

In operation, the customer places his/her foot in channel 26 (FIG. 1) such that the bottom of the foot is scanned by the laser unit which traverses safety glass 114. The system is independent of actual foot position due to the operation of the scanners. The scanners will accurately scan the distances of the bottom surface of the foot regardless if the foot position is askew on the glass. The tempered glass can be cleaned repeatedly and easily in a retail environment.

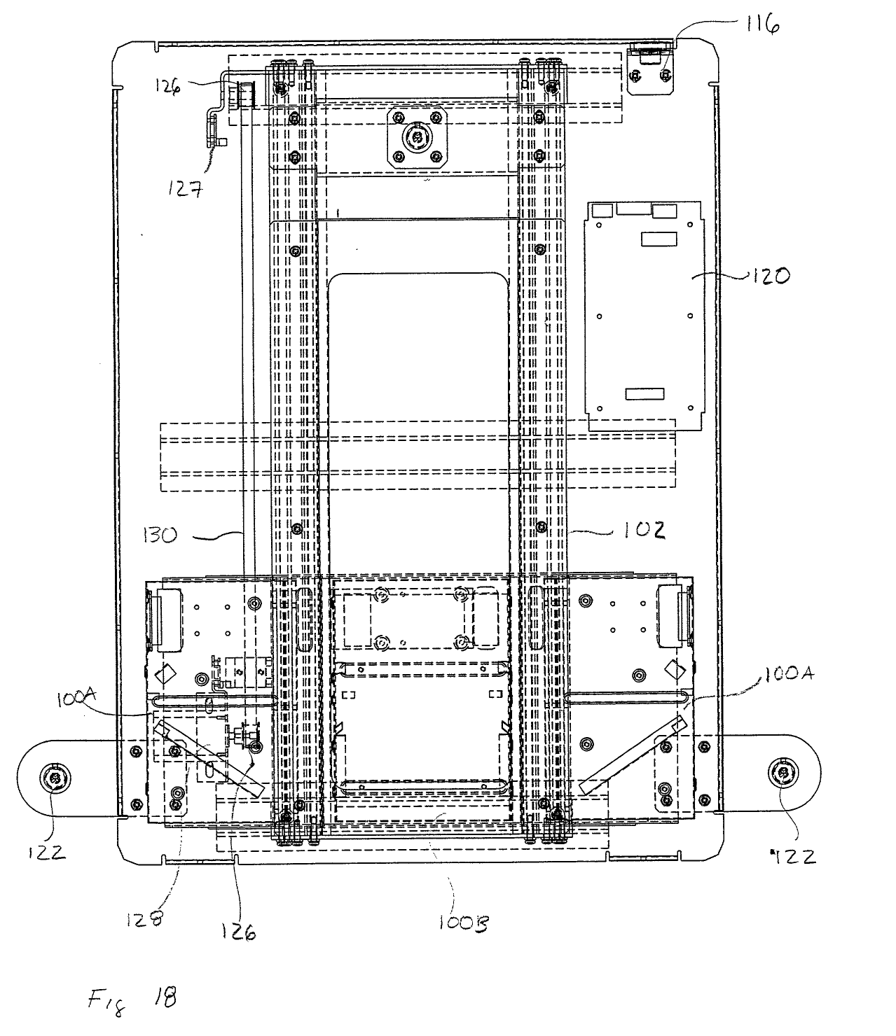

As shown in FIG. 15B each laser unit includes a housing 110 which encloses laser 160 and a laser opening 162 in the housing 110. A camera 164 and camera opening 166 are also located in housing 110. The electronics 168 and optics 170, including mirror 172, shown in FIG. 17, complete the laser unit. FIG. 15C illustrates the three laser units simultaneously scanning the foot. Referring again to FIG. 15A, data generated from the sweep of the laser units is processed by a shape grabber board 120, which is described further herein, and sent to milling station 10 via wiring connection 116.

Base 104 includes bar mounts 122 for attaching bar 22, and pole 23 thereto. FIG. 16 is a front view of the inner structure of the scanner structure and illustrates the position of the three laser scanning units 100A, B. Attached to the carrier 108 is a rail 124 which is positioned within support rail 102 such that the laser units travel along rails 102.

Movement of the laser scanning units 100 along support rails 102 is described with reference to FIGS. 16-18. Two pulleys 126 are located along support rails 102. One pulley is driven by a stepped motor 128 and movement between the two pulleys is coordinated by belt 130. Other mechanically equivalent means, such as a driven screw, can be used to move the units.

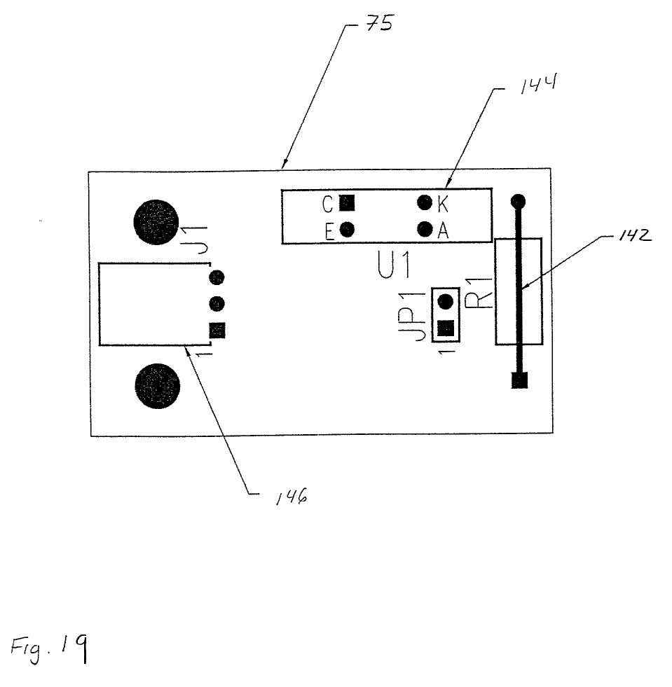

Bottom scanner unit 101B is also supported by carrier 108 for movement together with the side laser units 100A. As shown in FIG. 18, a homing board 127 is triggered by the movement of carrier 108.

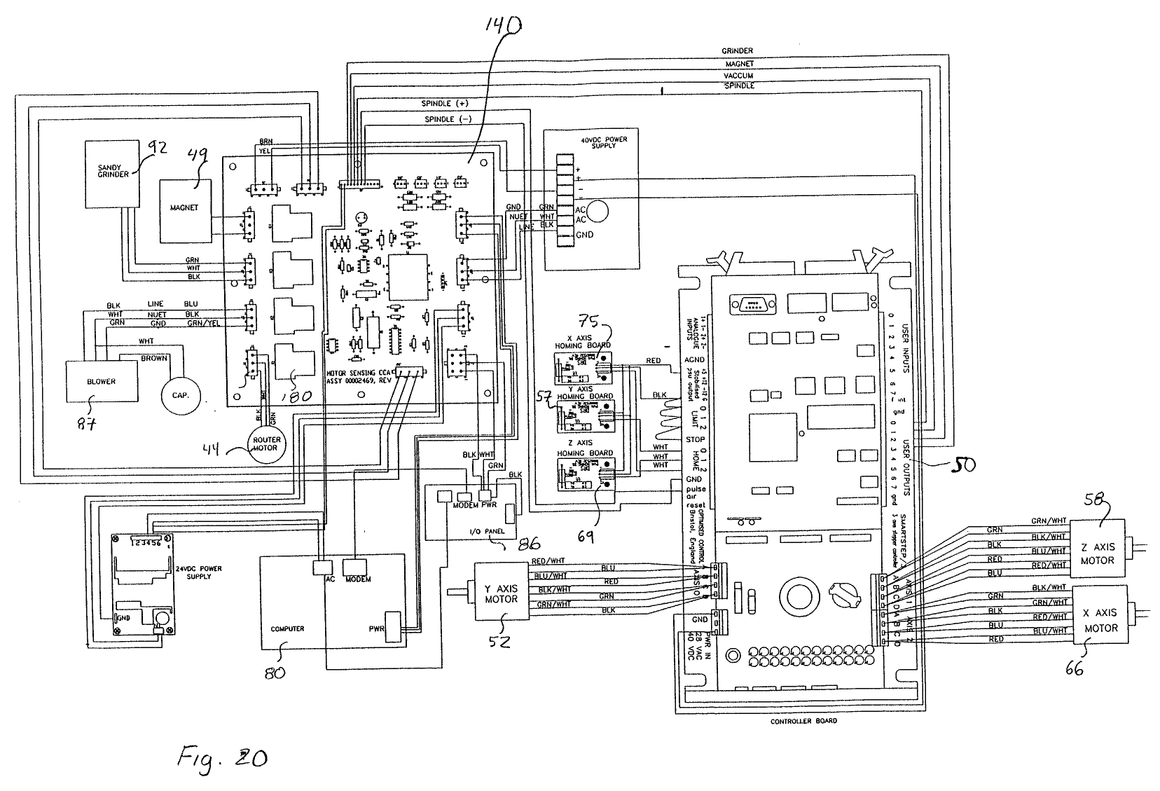

The homing boards 57, 69, 75 and 127 are shown in detail in FIG. 19. Since each board is constructed in the same manner, description will be made with reference to a singe board. Board 75 includes a resistor 142, opto switch 144 and connector 146. Homing boards 57, 69 and 75 act as optical limit switches for the respective stepper motors 52, 58, and 66. Each board acts as an optical switch whereby when the respective unit passes the board, reset thereof occurs.

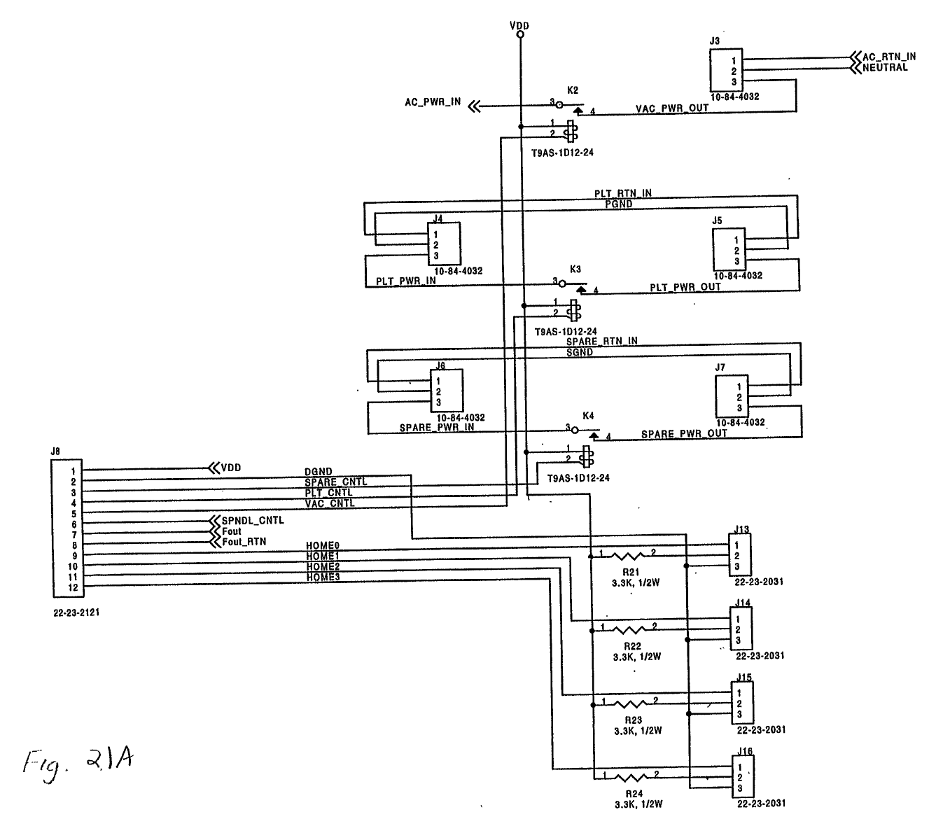

FIG. 20 is a wiring diagram of the milling station of the present invention. As shown, controller board 50 interfaces with stepping motors 52, 58 and 66, as well as, homing boards 57, 69 and 75. A motor sensing board 140 includes relays 138 and connectors 136 for each of the router 44, blower 87, grinder 92 and electro-magnet 49.

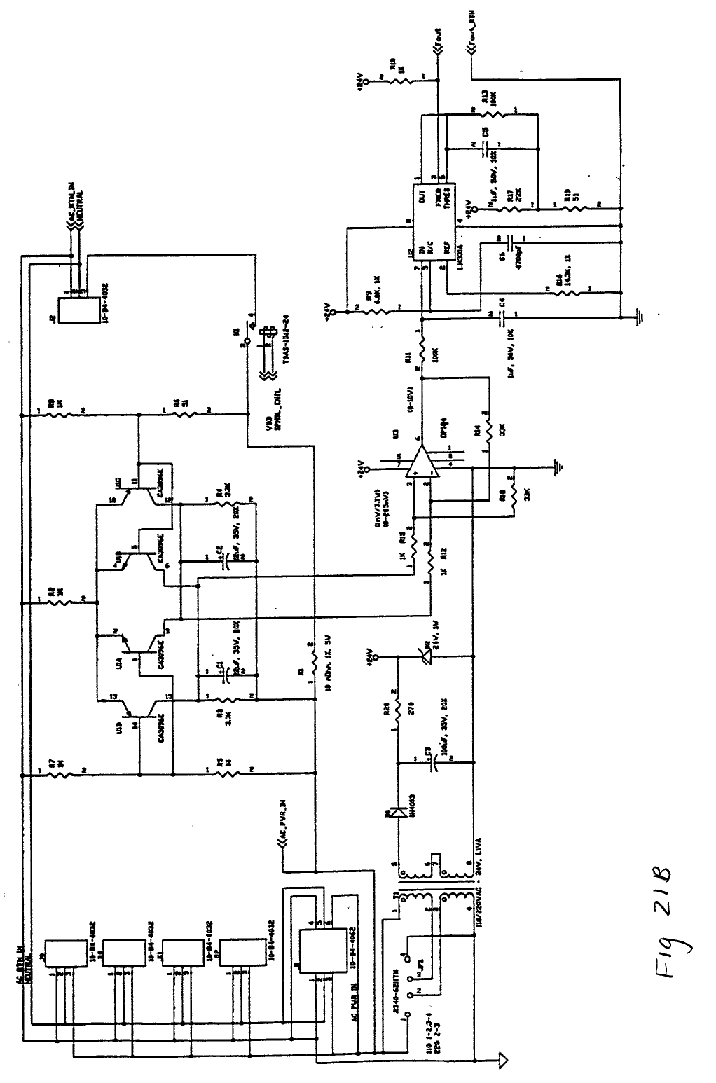

FIGS. 21A and 21B illustrate a circuit used for determining router motor current and more particularly to a circuit which can determine if the stepper motor feed rate should be sped up or slowed down.

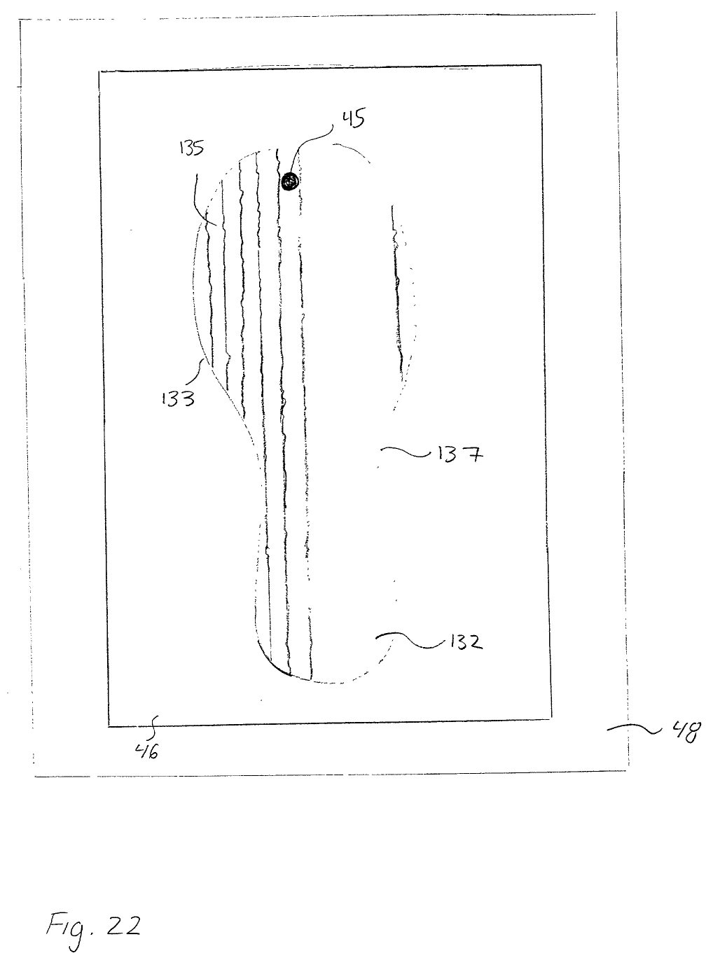

FIG. 22 shows an insole blank 132 during milling which is removably mounted on support plate 46 and movable tray 48. Initially, the router bit 45 begins the milling process at a first outside edge 133. The bit travels in one direction laterally through each pass 135. Stepper motor 52 controls the movement of router 44 along the length of insole blank 132. Typically, each path 135 is 3 to 4 mm. in width. However, the actual width of the pass can be larger or smaller depending on the manufacturing application. After bit 45 reaches the center of blank 132 tray 48 is moved by stepper motor 66 to continue milling inwardly from opposite edge 137. In this way, tearing of the outside edges of the insole is avoided, keeping the insole intact. As shown in FIG. 20, the system of the present invention also allows for the milling of the toe bar of the insole. This toe bar data can be removed prior to milling. After the insole has been milled according to the scanned image of the customers foot bottom, the operator can smooth the insole surfaces on grinder 92.

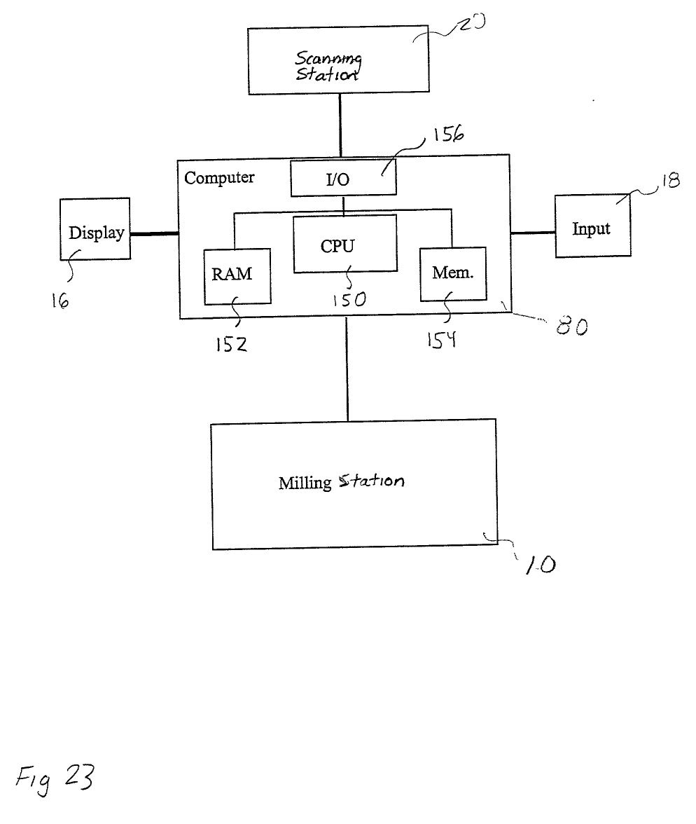

FIG. 23 is a schematic illustration of scanner station 20, milling station 10 and computer system 80 in particular. Computer system 80 includes central processing unit (CPU) 150, random access memory (RAM) 152, nonvolatile memory device 154, and input output interface (I/O) 156. Computer system 80 can be a standard personal computer, a minicomputer, a programmable logic controller, a CNC controller, hard-wired logic device, or any other logic device capable of carrying out the function described herein. CPU 150 can be a microprocessor, such as a PENTIUM™ manufactured by INTEL™. RAM 152 can include any type of standard memory useable as a work space for CPU 150 when carrying out a control program and can include a processor cache, a frame buffer for I/O 156, or the like. Memory device 154 can be any type of memory device capable of storing a control program and data files for execution by CPU 150, such as a magnetic hard disc or floppy disc, an optical disc such as a CD-ROM, or the like. The various components of computer 80 communicate with one another over a data bus which can be an Industry Standard Architecture (ISA) bus or any other standard or proprietary bus. I/O 156 includes the necessary signal conditioning and processing circuitry to interface scanners 100, display 16, and input device 18 with the data bus and for interfacing CPU 150 with an input of milling station 10. For example, I/O 156 can include an analog to digital convertor, a digital to analog convertor, fuses or other current limiting devices, filters, or the like. I/O 156 can also include a universal serial (USB) port.

Input device 18 is coupled to computer 80 for permitting the operator to input commands or data. For example, input device 18 can be a keyboard, keypad, track ball, mouse, stylus, touch screen or the like. Input device 18 is coupled to computer 80 through any appropriate interface included in I/O 156, such as through a serial or PS/2 port. Display 16 serves to display menu choices, prompts, data entry screens, operating status indicators, error messages, or any other appropriate information, to the operator. Display 16 can be a CRT, LCD, plasma or the like, display. Alternatively, display 16 can be a printer, a series of pilot lamps, or other type of indicator depending on the desired amount of operator prompting and feedback during operation. Display 16 is interfaced to computer 80 through a standard VGA port in I/O 156 or in any other manner.

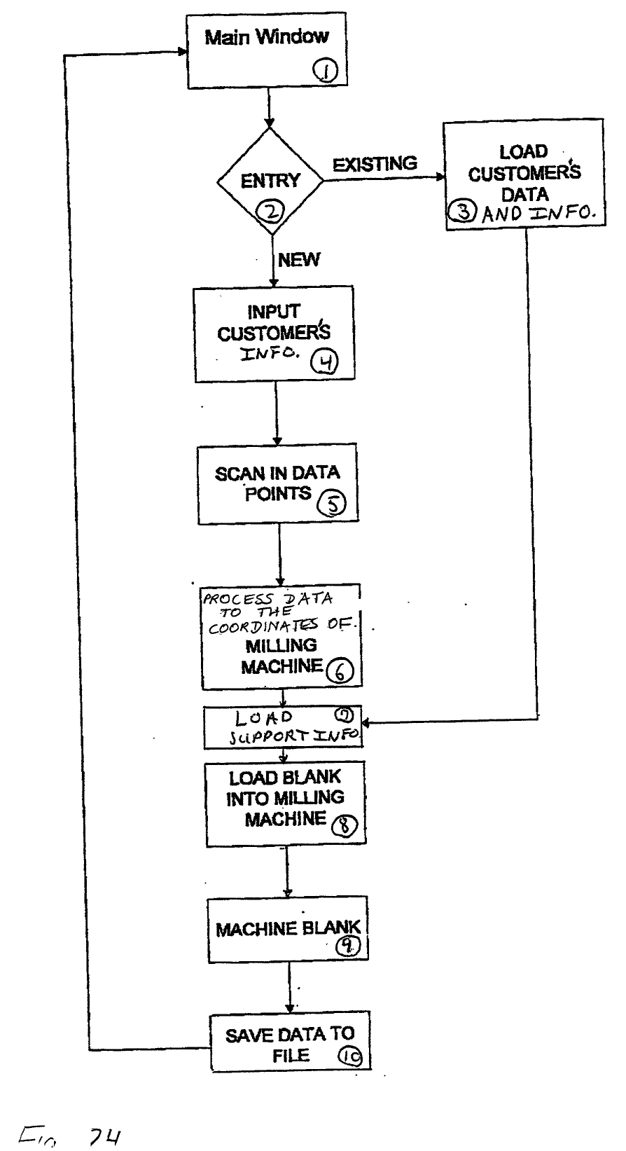

A control program stored in memory device 154 is executed by CPU 150 to carry out the functions described herein. The control program can be written in any programming language, such as basic, C++, or the like. Memory device 154 also stores a compatible operating system such as Microsoft Windows 98™. FIG. 24 is a flow chart of the software routine executed by CPU 150 in accordance with the control program. In step 1, a main window or menu is displayed on display 16 to let the operator know that the system is ready for operation and to prompt operator input. In step 2, the operator selects a menu selection, check box, on-screen button, or the like, to select either a new customer or an existing customer. A new customer is one who has not had their foot scanned by the system previously. An existing customer has had their foot scanned and thus customer contour data has been collected and stored in accordance with the shape of the customer's insole.

If a new customer is to be scanned, the operator selects “new customer” in step 2 by operating input device 18 in the appropriate manner and the routine advances to step 4. Step 3 relates to an existing customer and will be described below. In step 4, customer information is inputted. The customer information can include the customer's name, address, age, sex, type of shoe for insert (e.g. running shoe), height, weight, or any other customer specific information. The customer information is entered using input device 18 by filling in a form on display 16, by selecting menu selections on display 16, or in any other appropriate manner. The customer information is stored temporarily in RAM 152. The customer information can be stored in a spreadsheet format, such as Microsoft Excel™ format, or in a database format, such as Microsoft Access™ format to be read and processed by CPU 150.

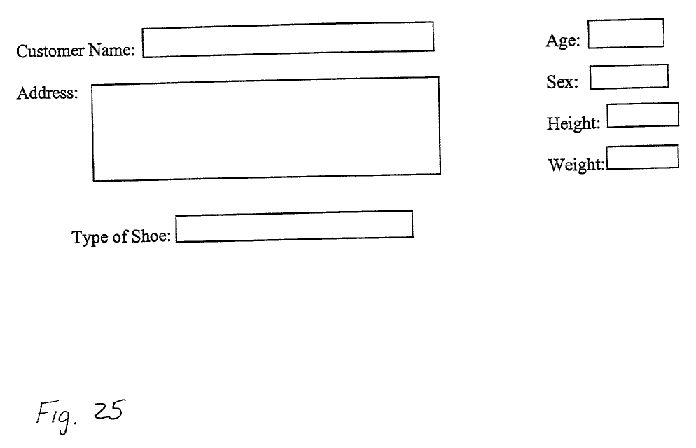

FIG. 25 is an example of a form that can be displayed in step 4 to allow the operator to fill in the customer information. Plural consecutive screens can be displayed or all information can be entered in one screen depending on the amount and complexity of the information. Of course, the form can utilize drop down selections, verification routines, or any other data entry facilitating methods. Any desired customer information can be requested and entered in step 4. Customer information, such as, the blank size and the shoe size, can be viewed by the operator. If the operator chooses, he/she can turn off the shoe size information.

Referring again to FIG. 24, in step 5, the customer's foot contour data is scanned by placing the customer's foot in the scanning station and operating the scanner(s) in the manner described above. As the laser scans the bottom surface and edges of the customer's foot, three-dimensional customer contour data is collected and stored in RAM 152 in a known manner. For example, known triangulation methods can be used to determine the precise location in three-dimensional space of plural points on the customer's foot, as previously set forth.

In this manner, a three-dimensional map of the bottom of the customer's foot is obtained. The contour data can be processed to the coordinates of the milling machine in step 6 to obtain a continuous smooth contour of the bottom of the customer's foot. Various methods for smoothing data points are well known and can be used appropriately in connection with the preferred embodiment. For example, data averaging, spline fitting, or least squares techniques can be used. Also, step 6 can be used to remove unwanted portions of the insole, such as the removal of a toe bar section.

Once the customer contour data is obtained and optionally smoothed, milling of the insert can be accomplished. In step 7, support information is loaded into computer 80 to select a blank and facilitate machining. For example, the support information contains data for matching a shoe size, and thus a blank size, to the customer contour data. The support information can also include data relating to the material for a blank to select the most appropriate material based on the customer information and customer contour data. The most appropriate material and size for the blank can then be displayed on display 16 to assist the operator in loading the blank into milling assembly 40. Typically, for half-sizes, the blank size is rounded up to the next whole size. In step 9, the blank is machined in the manner described above to produce the insole in accordance with the customer contour data.

In step 10, the customer contour data, customer information, and any other information related to the machining process is saved and stored in files associated with the customer on memory device 154 for subsequent recall and use.

When an existing customer is selected in step 2, the process proceeds to step 3 in which previously stored customer information and customer contour data is recalled from memory device 154 and loaded into RAM 152. The customer information and contour data can be displayed for confirmation or editing by the operator. For example, the customer's address may have changed and thus requires updating. Also, the customer may now require an insert for walking shoes when previously the customer required athletic shoes. The confirmed and edited customer information and contour data is then used to machine an insert beginning at step 7 in the manner described above.

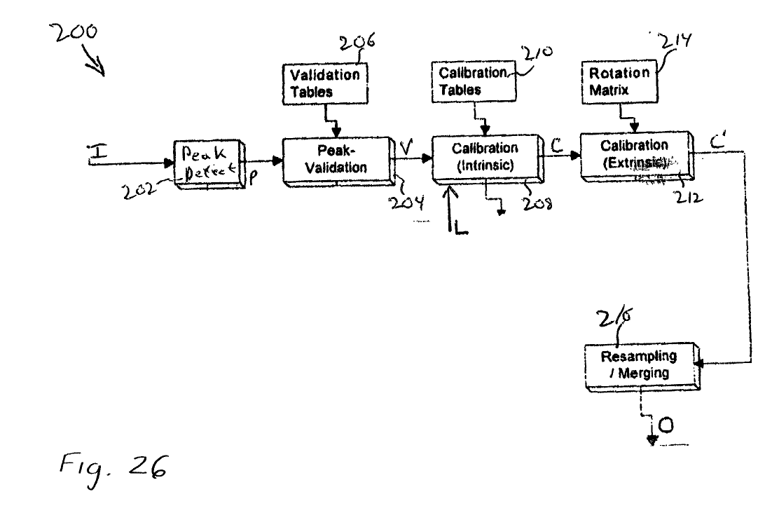

FIG. 26 is a block diagram illustrating the signal conditioning algorithm 200 of computer 80 to provide contour data based on an output of scanning station 20. The various functions of algorithm 200 are illustrated as blocks for the purpose of explanation. However, the signal conditioning functions can all be conducted by CPU 150 of computer 80 in accordance with the control program. Input signal I is transmitted from scanning station 20 to computer 80 using any known communication protocol, such as the Universal Serial Bus (USB) protocol, and subjected to peak detection function 202 to ascertain potential return signals from the bottom surface of the foot as signal P. For example, the peak detection method disclosed in U.S. Pat. No. 4,658,368, the disclosure of which is incorporated herein by reference, can be used. Input signal I can also be transmitted, stored, or displayed as a raw video signal for archival or other purposes. Signals P can be displayed for focusing and calibration adjustments. Region Of Interest (ROI) techniques can be used to speed up real time display. Due to “clutter” from other light sources, such as the ambient light in a store, some of the peaks in signal P may correspond to “false” return signals that are the result of light reflected from sources other than the lasers in laser units 100A and laser unit 100B. Therefore, it is desirable to subject signal P to peak validation function 204 to eliminate the false peaks or return signals. In particular, the method of peak validation disclosed in U.S. Pat. No. 5,270,795, the disclosure of which is incorporated herein by reference, can be utilized to obtain validated signal V. Parameters stored in peak validation table 206 are used for peak validation function 204.

Validated signal V is subjected to calibration function 208 which accomplishes an intrinsic calibration, in a known manner, to correct for errors internal to the laser units 100A and laser unit 100B, such as optical distortions inherent in the lens system and the mirrors, and mechanical tolerances. The inputs of intrinsic calibration function 208 are peak validated signal V and video line signal L from the CCD of laser units 100A and laser unit 100B. A set of calibration equations, using parameters stored in calibration table 210, are used to convert these inputs into signal C which represents the x-y-z contour coordinates relative to the housing of laser units 100A and laser unit 100B only.

Signal C must be corrected for orientation of the mounting holes used to mount laser units 100A and laser unit 100B, tolerances in the mechanical parts, and the like. Furthermore because three laser units are calibrated into one global coordinate system, each laser unit is registered with respect to the others. Such correction is accomplished by extrinsic calibration function 212, in a known manner. Extrinsic calibration function 212 is accomplished by equations using parameters stored in rotation matrix 214, in a known manner, to obtain calibrated signal C which represents absolute x-y-z coordinates.

Each of laser units 100A and 100B produces data, or a signal, that corresponds to the shape, or contour, of the foot. Therefore, while the signals discussed above are treated as singular for the purpose of clarity, there are actually three components to each signal, i.e. three contour images. Although the images are registered by function 212, i.e. are in the same coordinate system, one contour point from laser unit 100A can be the same point detected by laser unit 100B. However, the points are stored at different addresses in memory unit 154 of computer 80. Re-sampling and merging function 216 produces one single set of data where redundant data points are eliminated and filtered to obtain output signal O that represents a single contour image of the foot. Function 216 can be accomplished by transformation to cylindrical coordinates or other known techniques such as working with surfaces (e.g. spline and surface fitting), generalized objects, or construction of a 3-D volumetric representation of the foot.

Although described in relation to forming a custom-made shoe insole, the present invention could be used to mill a support for other body portions. Moreover, it should be appreciated that the entire surface of the foot and upper ankle can be measured. The system and method of the present invention simultaneously sizes the foot easily based upon the measured coordinates. It should also be appreciated that other forms of laser scanning may be utilized without departing from the teachings of the present invention.

Given the above, the present invention provides a method and system for forming a custom shoe which will conform exactly to the undersurface of a customers foot.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method of forming a custom-made insole comprising the steps of:
randomly positioning a foot to be measured on a laser scanning station;
passing at least one laser scanning unit along an undersurface of the foot;
scanning the undersurface of the foot with the at least one laser scanning unit;
measuring surface coordinates of the undersurface detected by the at least one laser unit;
processing the measure surface coordinates;
transmitting the processed measured surface coordinates to a data processing unit; and
milling a custom-made insole based on the transmitted surface coordinates.

2. The method of claim 1, wherein the step of scanning the undersurface of the foot comprises directing a line of laser light along the undersurface.

3. The method of claim 2, wherein the step of scanning the undersurface of the foot comprises directing a non-focused fan-shaped line of laser light along the undersurface and edges of the foot.

4. The method of claim 2, wherein the step of measuring the surface coordinates of the foot comprises determining a three-dimensional map of the undersurface of the foot.

5. The method of claim 4, wherein the step of processing the measured coordinates includes performing intrinsic calibrations to compensate for optical distortions of the at least one laser scanning unit.

6. The method of claim 5, wherein a plurality of laser scanning units are passed along an undersurface of the foot and the step of processing the measured surface coordinates includes performing extrinsic calibrations to calibrate the plurality of scanning units into one global coordinate system.

7. The method of claim 1, further comprising the step of removably mounting an insole blank to a tray of a milling assembly.

8. The method of claim 7, wherein the step of milling comprises moving a router along a first axis of movement to mill the insole blank along a length thereof.

9. The method of claim 8, further comprising the step of moving the router along a second axis of movement to vary the depth of milling along the insole blank.

10. The method of claim 9, further comprising the step of moving the tray along a third axis of movement to mill the insole along a width thereof.

11. The method of claim 10, wherein the movement of the router and tray along the first, second and third axes of movement is determined by the measured surface coordinates transmitted to the computer.

12. The method of claim 11, further comprising the step of forwarding the measured surface coordinates from the computer to a plurality of stepper motors, wherein one stepper motor controls the movement of the router along the first axis of movement, a second stepper motor controls the movement of the router along the second axis of movement and a third stepper motor controls the movement of the tray along the third axis of movement.

13. A system for forming a custom-made insole, comprising:
at least one scanning station for supporting a foot to be measured, the scanning station including at least one movable laser scanning unit for determining coordinates of an undersurface of the foot;
at least one milling station in communication with the scanning station, the milling station including a milling assembly for forming the custom-made insole; and
control means for controlling the operation of the milling assembly based upon the coordinates determined by the at least one laser scanning unit.

14. The system of claim 13, wherein the at least one scanning station includes a base for supporting the foot, the at least one laser scanning unit being movably disposed beneath the base.

15. The system of claim 14, wherein the at least one laser scanning unit is mounted to a carrier which is movable along a length of the base.

16. The system of claim 15, wherein the base is made of tempered, safety glass and the at least one laser scanning unit emits a fan of laser light through the glass to measure the undersurface and edges of the foot.

17. The system of claim 13, wherein the at least one laser scanning unit includes a first and second side portion extending upwardly from the base along the length thereof.

18. The system of claim 17, wherein the base, and the first and second side portions are made of tempered glass.

19. The system of claim 18, further comprising a plurality of laser scanning units, wherein a laser scanning unit is movably disposed along the base, the first side portion and the second side portion, respectively.

20. The system of claim 13, wherein the control means is a computer disposed in a lower stand of the milling station.

21. The system of claim 20, wherein the milling station includes a display device and an input device for entering and displaying customer information.

22. The system of claim 13, wherein the milling assembly is disposed in an upper unit of the milling station.

23. The system of claim 22, wherein the milling assembly includes a tray for removably mounting an insole blank thereto and a router for milling the insole blank.

24. The system of claim 23, wherein the router is movably disposed within the milling assembly to move along a first axis of movement whereby the router moves along a length of the insole blank.

25. The system of claim 24, wherein the router is movably disposed in the milling assembly to move along a second axis of movement to vary the depth of milling along the insole blank.

26. The system of claim 25, wherein the tray is movably disposed within the milling assembly to move along a third axis of movement such that the insole blank can be milled along a width thereof.

27. The system of claim 26, further comprising a plurality of stepper motors in communication with the computer means, wherein one stepper motor controls the movement of the router along the first axis of movement, a second stepper motor controls the movement of the router along the second axis of movement and a third stepper motor controls the movement of the tray along the third axis of movement.

28. The system of claim 13, further comprising vacuum means disposed in the at least one milling station for removing particles produced during milling of the insole.

29. The system of claim 28, wherein the vacuum means includes an air plenum having an entrance located in the vicinity of the milling assembly.

30. The system of claim 28, wherein the vacuum means operates at a high volume and low velocity to remove the particles from the milling assembly.
